(19) United States
(12) Patent Application Publication
(10) Pub. No.: US 2014/0123014 A1
(43) Pub. Date: May 1, 2014

(54) METHOD AND SYSTEM FOR CHAT AND ACTIVITY STREAM CAPTURE AND PLAYBACK

(71) Applicant: Sean Patrick Keen, Chicago, IL (US)

(72) Inventor: Sean Patrick Keen, Chicago, IL (US)

(73) Assignee: INXPO, INC., Chicago, IL (US)

(21) Appl. No.: 14/070,238

(22) Filed: Nov. 1, 2013

Related U.S. Application Data
(60) Provisional application No. 61/721,330, filed on Nov. 1, 2012.

(51) Int. Cl. H04L 12/58

(52) U.S. Cl. CPC H04L 51/046
USPC 715/719

(57) ABSTRACT

Aspects of present disclosure involve systems and/or methods for capturing and streaming a live event and corresponding chat activity. The present disclosure describes a system for capturing a live event using an audio and/or video capture device, broadcasting the event as a webcast to one or more viewers who may provide feedback, comments, and pose questions using an online chat system, and recording the event and the online chat for later, synchronous, playback.

### CROSS REFERENCE TO RELATED APPLICATION

The present non-provisional utility application claims priority under 35 U.S.C. §119(e) to co-pending provisional application No. 61/721,330 entitled “Method And System For Chat And Activity Stream Capture And Playback,” filed on Nov. 1, 2012 and which is hereby incorporated in its entirety by reference herein.

### TECHNICAL FIELD

Aspects of the present disclosure relate to a system for playing and recording interactive webcasts.

### BACKGROUND

In the world of online broadcasts and webcasts, users are often provided with the opportunity to contribute text-based comments. For example, during a broadcast or live presentation, users may have the ability to type in questions that are sent privately to the presenter, or participate in a public (visible to all users), text-based chat. After the presentation has ended, a user's ability to provide such comments may change, such as for example, to a message board style system, or other mechanism for providing comments and feedback.

While such methods enable users to engage in text-based commenting during the live presentation, users typically cannot view the comments after the broadcast of the live presentation has ended. Moreover, to the extent that users can view any of the comments that were received during the live presentation, the comments are often provided with little to no context. State differently, if a user can see any comments provided during the live presentation, the user can only see the literal text of the comment, without any context as to its relevance to the previously broadcasted presentation.

It is with these concepts in mind, among others, that various aspects of the present disclosure were conceived.

### SUMMARY

Aspects of the present disclosure include methods for on-demand streaming of a hybrid recording of a live presentation. The method includes recording a live presentation using at least one capture device. The method further includes recording, in a memory, comments entered into an online chat window displaying a stream of the live presentation. The method includes streaming a hybrid recording to a user computer over a network in response to a user request to view the hybrid recording. The hybrid recording includes the recording of the live presentation, the comments retrieved from memory and wherein the recording of the live presentation and the comments are simultaneously and synchronously displayed in a streaming window.

Aspects of the present disclosure also include a system for on-demand streaming of a hybrid recording of a live presentation. The system includes at least one capture device to record a live presentation. The system further includes at least one processor to record, in a memory, comments entered into an online chat window displaying a stream of the live presentation. The at least one processor is further configured to stream a hybrid recording to a user computer over a network in response to a user request. The hybrid recording includes the recording of the live presentation and the comments retrieved from memory. Wherein the recording of the live presentation and the comments are simultaneously and synchronously displayed in a streaming window.

Aspects of the present disclosure include a non-transitory computer-readable medium encoded with instructions for on-demand streaming of a hybrid recording of a live presentation. The instructions are executable by a processor and include recording a live presentation using at least one capture device. The instructions include recording, in a memory, comments entered into an online chat window displaying a stream of the live presentation. The instructions further include streaming a hybrid recording to a user computer over a network in response to a user request. The hybrid recording includes the recording of the live presentation and the comments retrieved from memory. Wherein the recording of the live presentation and the comments are simultaneously and synchronously displayed in a streaming window.

### BRIEF DESCRIPTION OF THE DRAWINGS

FIG. 1 is an example of a system for playing and recording interactive webcasts over a network.

FIG. 2A is an example of a webcasts application used on viewer computing devices in a system for playing and recording interactive webcasts.

FIG. 2B is an example of a chat window used on viewer computing devices in a system for playing and recording interactive webcasts.

FIG. 3 is an example process for on-demand streaming of a live presentation, according to aspects of the present disclosure.

FIG. 4 is an example of a general computing device that may be used in a system for playing and recording interactive webcasts.

### DETAILED DESCRIPTION

Implementations of the present disclosure involve a system and/or method for capturing and streaming a live event and chat activity. More specifically, the disclosure includes a system for capturing a live event using an audio and/or video capture device, broadcasting the event as a webcast to one or more viewers who may provide feedback, comments, and pose questions using an online chat system, and recording both the event and the online chat for later playback. The recording of the webcast may be streamed over a network to viewers using various types of computing systems. The viewers may use a webcast application to access a live video stream of the event, materials being presented at the event, and a chat window for interacting with other viewers and a presenter or moderator at the event. Furthermore, in addition to recording the event itself, the feedback, questions, and comments entered into the chat window may be recorded along with a timestamp of when they occurred for use with future “on-demand” playback. The recording may be played back at a later time “on-demand” by a viewer using a computing device running the webcast application. The playback may include the audio/video from the event synchronized with the playback of the feedback, questions, and comments, entered into the chat window according to the timestamps of when they happened in relation to the actual event. Accordingly, playback of the event may occur from the same perspective as when it occurred live, such that the context of chats are synchronized with the subject matter of the broadcast. The present disclosure may also be viewed in conjunction with Appendix A, which includes 15 pages of text and drawings and which is hereby incorporated by reference herein.

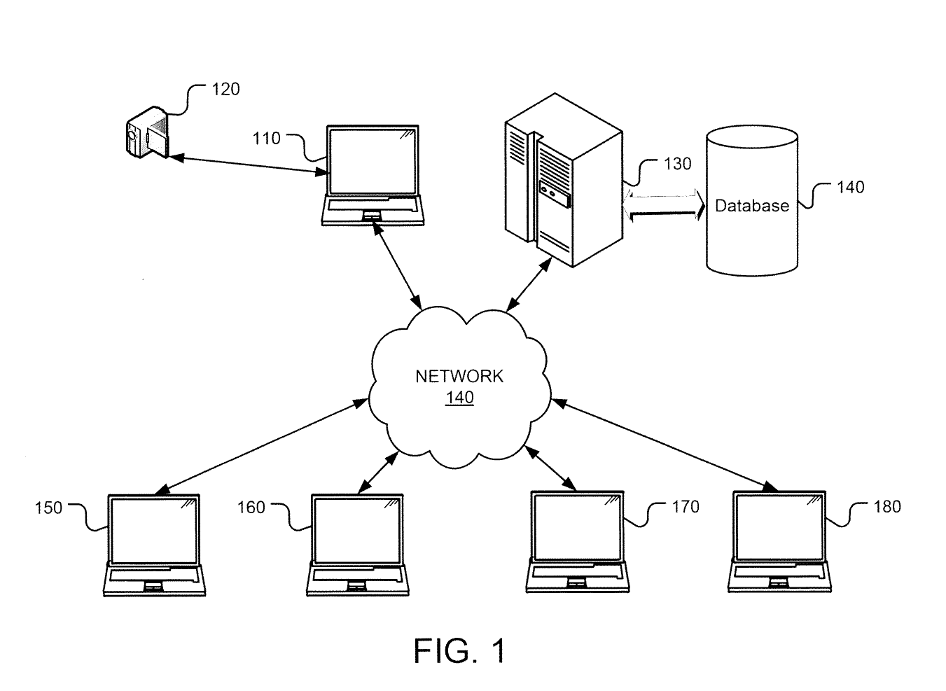

FIG. 1 illustrates a system for broadcasting and replaying an event as a webcast. The event may be any event or presentation and may include various speakers or other presenters, along with presentation materials. The system may include a capture device 120 connected to a presenter computing device 110 that broadcasts the recording to a server 130 via a network 140. The server 130 may record the audio/video data captured by the capture device 120, and may also broadcast a webcast over the network 140 to one or more viewer computing devices 150, 160, 170, 180.

The recording device 120 may include any type of video or audio capture device such as a conventional video camera that records both video and audio or an audio capture device. The presenter computing device 110 may also send presentation materials along with the audio video data to the server 130. The presentation materials may include any multimedia materials that correspond to the event or presentation. For example, the presentation materials may include a slideshow, pictures, videos, charts, or any other electronic multimedia materials. Along with the recording of the presenter, the presentation materials may be uploaded or “streamed” to the server in real-time. The type of recording device 120 used may vary depending on the type of presentation or event taking place. For example, in the case of a presentation that uses an electronic slideshow, it may be appropriate to only record audio of the speaker and to coordinate the audio with a slide show (e.g., PowerPoint presentation). In other cases, a presentation may be given entirely by a speaker who may or may not use physical props and an audio/video recording made by a video camera may be more appropriate. In either case, as the event takes place, the event and any data associated with the event may be recorded at a server and then broadcast over a network for viewing by one or more viewers either live, “simu-live” (a pre-recorded event that is broadcasted at a scheduled time to simulate a live presentation) or at a later time “on-demand.”

The server 130 receives the live stream of the presentation and corresponding presentation materials and both broadcasts the presentation over the network 140 as a webcast and stores the event or presentation for on-demand viewing. The server 130 may include any conventional server configured to send and receive data over a network. More specifically, the server is configured to receive audio, video, and data files as a stream and to broadcast the stream to one or more computers either as a live stream or on an on-demand basis. The server is also configured host an online chat with two or more computing devices and to store the chat along with a database 135 maintaining a log of timestamps of when incidents (e.g., chats) happen (“cue points”).

Viewers may watch the event using a webcast application operating on a computing device 150-180 connected to the server 130 using the network 140. The network 140 may include any conventional computing network linking the recording device at the event to the user's computing device. For example, the network 140 may include a company's intranet, a location's intranet, an extranet, and the Internet. In most implementations, some part of the system will communicate over the Internet, at least in part. The computing devices 150-180 may include any electronic device capable of connecting to the network 140 and playing the presentation as well as receiving a feedback from the user. For example, the computing devices 150-180 may be personal computers, laptop computers, tablet computers, smart phones, or any other Internet capable device.

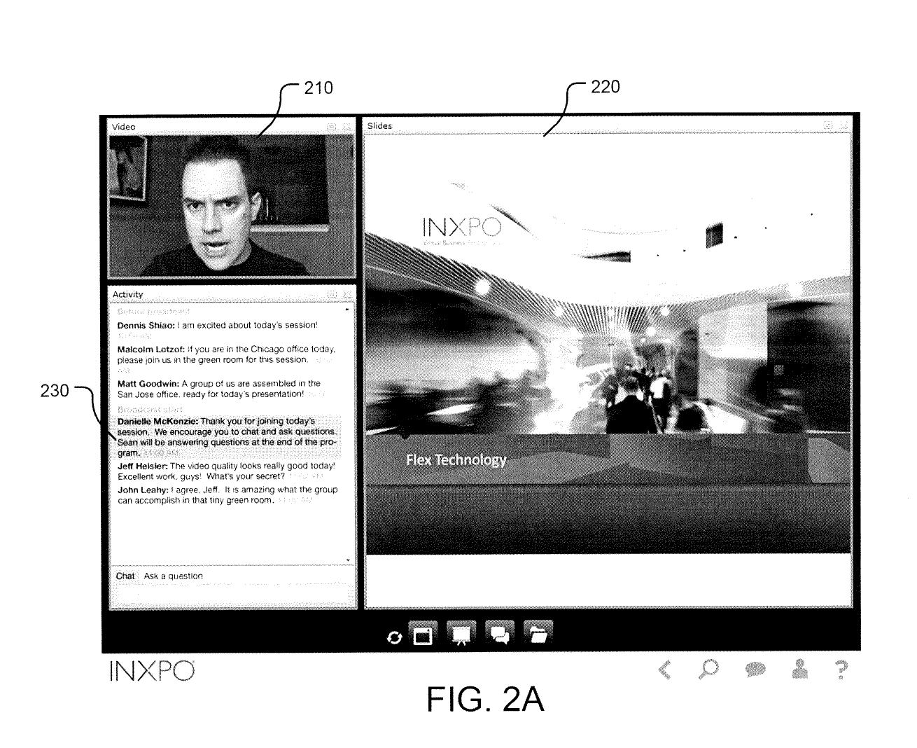

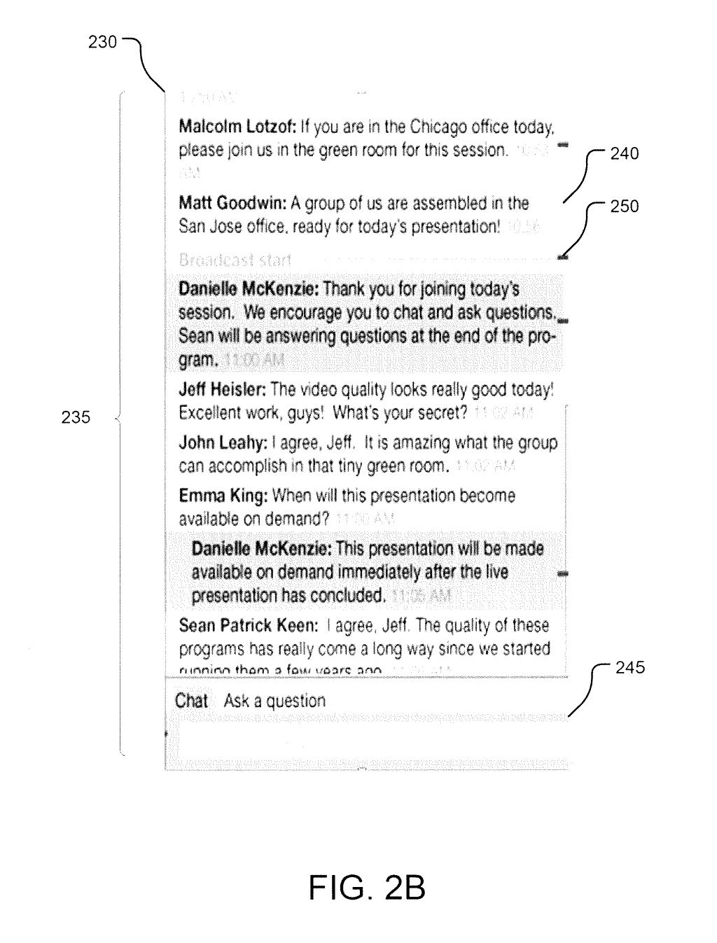

The event may be viewed by remote viewers by way of the recording streaming over the network 140 to the user's computing devices 150-180 running a webcast application. Referring to FIG. 2, each of the computing devices 150-180 may operate a webcast application 200. The webcast application 200 is configured to connect to the server 130 and to stream audio, video, the presentation material, and allow for viewers to interact with the presenter, moderators, and other viewers using a chat window. The webcast application 200 may include an audio/video window 210, a presentation materials window 220, and a chat window 230. The stream may include information to populate each of these windows. The stream may be either a live stream, in which case the webcast application is configured to allow the user to participate in the chat portion, or the stream may be an on-demand stream of a prior occurring event, in which case the user can view the event and the corresponding chat synchronized to the event, in the form of a hybrid recording (i.e., includes both the recording of the live presentation or event and the corresponding chat comments simultaneously).

When viewing the event on-demand, the chats and presentation materials appear at the same time relative to the start of the event as they did when the event was live. Stated differently, during the on-demand playback of a session, lines of chat and answered questions are drawn into chat stream in the order that they originally appeared during playback. For example, assume a user submits the first comment into the chat stream two minutes into the live broadcast. When an on-demand viewer loads the on-demand webcast, the chat stream is empty. Once the playback head of the video (or audio) reaches the 2:00 minute mark, the comment will appear in the chat stream. This will continue for all remaining comments and answered questions, replicating the live presentation.

On-demand playback may include various transport controls for pausing, rewinding and fast forwarding the playback of the presentation materials. For example, if the on-demand playback is paused, the chat stream will pause as well. If a user fast forwards, new content will instantly appear in the chat stream to maintain synchronization. Likewise, pausing and rewinding can cause content to disappear from the chat stream.

It is possible for a user to submit a comment or question during on-demand playback of a presentation, presentation materials, and/or chat stream for a webcast. For example, if a user submits a chat comment during the on-demand playback, the question will be immediately posted to the chat stream as if the user were watching live. Doing so allows the user to make comments in context to the presentation/presentation materials that is being played back, on-demand, as well as in context with the comments that were provided during the live presentation.

Once the webcast begins, the audio/video window 210 is configured to playback any incoming audio or audio/video streams. For example, the audio/video window 210 may be used to show the webcast of the presenter at an event.

The webcast application 200 may include a scrollable chat window 230 that displays messages, questions, comments, and answers as they are entered. This is often referred to as a “chat stream.” The chat window 230 operates such that each new item entered into the chat window 230 may be placed at the bottom of the chat window 230. Once the window is full, the window may begin scrolling as new items are entered. A scroll bar may be added once the chat window 230 is full, allowing viewers to review past questions and comments. Viewers may chat with anyone connected. Their chats may be immediately posted to the chat stream.

According to one embodiment and as illustrated in FIG. 2B, the chat window 230 may include a content area 235 that generally contains a chat entry area 240 and a submission area 245, in conjunction with various other interfacing components. The content area 235 contains one or more comments. Each comment entry begins with a user's name, followed by the text string and a time stamp. The user name is hyperlinked to various information about the user, such as user profile information. The timestamp is localized so that it is displayed in the time zone of the user viewing the stream. Comments, chat entries, and the like, provided by parties other than users, such as a moderator may be highlighted in a number of ways to differentiate them from user comments. For example, moderator comments may be highlighted by using a grey background and further indented with respect to user questions or comments. Each entry into the chat stream may be logged as a cue point and stored in the database 135 connected to the server 130.

In one embodiment, the content area 235 of the chat window 230 represents a running log of the chat stream (Q & A and chat) activity that updates in real time, such as when new comments are submitted, or as new questions are answered. The submission area 245 contains two tabs—“Chat” and “Ask a Question.” Users can click on a tab, depending upon the type of text they want to submit, and then type in the field and click “enter” to submit their string.

In one embodiment, one or more “activity” stamps 250 may be visualized on the chat window 230 that identify when the activity within the chat stream occurred. Activity stamps include “before broadcast,” “during broadcast” and “after broadcast,” and are immediately added during a live session when the broadcast is started and stopped.

Chatting, commenting (i.e. posing questions and answers), may start before the webcast and/or stream and any chat log may be marked to indicate that the comments were entered before the broadcast began. Alternatively, chatting, commenting, and/or posing questions may start during the actual webcast and/or stream, or after the webcast and/or stream has ended and the chat log may be marked to indicate when the comments were entered accordingly.

Other configurations of the webcast and/or stream include the designation of one or more moderators. Moderators have unique abilities not available to other users. Moderators can supply answers to user questions. In addition, moderators have the ability to censor the stream, such as for example, by deleting chat content presentation materials, etc. Questions may be sent to webcast moderators and not visible to the audience as a whole unless the question is answered by the moderator. The answer may be via chat or audio, or some combination thereof. Choosing between chatting and asking questions may be done by entering text into a specific entry box, by selecting an option in a menu, such as a dropdown menu, or by selecting a tab for toggling between the options.

Referring back to FIG. 2A, the materials window 220 may be configured to allow for the presentation of any relevant electronic materials. For example, the materials window 220 may be configured to show slideshows, videos, and pictures. The materials window 220 may also be configured to be controlled by a presenter, a moderator, or a timer, so that material, such as PowerPoint slides, are presented in the window and coordinate with the overall presentation. Each time the presentation material shown in the materials window 220 is changed, a cue point logging the change may be created in the database connected to the server.

Each cue point that occurs during the webcast may be logged in a database connected to the server with a timestamp corresponding to the duration of the webcast. A cue point includes any new information being presented or any change in status. For example, if a presenter switches to a new slide 5 minutes and 53 seconds after initiating the broadcast, the database recording the event may be updated to include that the particular slide push occurred in the materials window 220 at 5:53. The material pushed at that time is also recorded. Similarly, if a comment was made or a question was answered in the chat window 230 at 6 minutes and 30 seconds into the webcast, the database may be updated to include a cue point with the question/answer or comment along with the timestamp. This occurs for every new comment, new answered question, slide change, or any other addition of new information during the webcast. All aspects of the presentation are logged in the database 135 using the cue points so that they may be replayed at the correct time relative to the start of the event.

After a webcast has completed, the audio/video of the webcast as well as the chat logs may be stored in a persistent memory along with the database 135 of the cue points. Viewers, both new and old, may elect to view/review a stored webcast at any time. This on-demand viewing may include all of the information that was delivered during the original broadcast and displays it at the appropriate time. For example, when the viewer initiates an on-demand viewing, the system will start the audio or audio/video feed and query the database for all of the cue points. These cue points will list each of the times that each incident occurred. For example, chat entries that were entered into the chat stream before the original webcast started, may be populated into the chat window 230 and labeled as occurring before the original webcast started. Similarly, presentation material that was showing before the original webcast started, such as a first slide in a slideshow, may be loaded into the materials window 220 once the on-demand webcast starts. Once the information related to the cue points for the incidents that occurred before the original webcast stared have been populated, the system may then add entries into the chat stream or change the materials being presented in the materials window 220 according to the cue points stored in the database. For example, if comment #1 occurred at 1 minute and 3 seconds into the webcast, during on-demand playback, comment #1 would be shown at 1 minute and 3 seconds into the on-demand webcast. Similarly, if a slide was change from slide 1 to 2 at 2 minutes into the webcast, during the on-demand webcast the slide shown in the materials window 220 would change from slide 1 to 2, 2 minutes from the start of the on-demand webcast. The result is that during the on-demand webcast, all of the incidents that happened during the live webcast, whether they be new comments in the chat stream or new materials being show in the presentation window 220, will be shown at the same time relative to the start of the on-demand webcast giving the context of any chats, questions, comments, and answers.

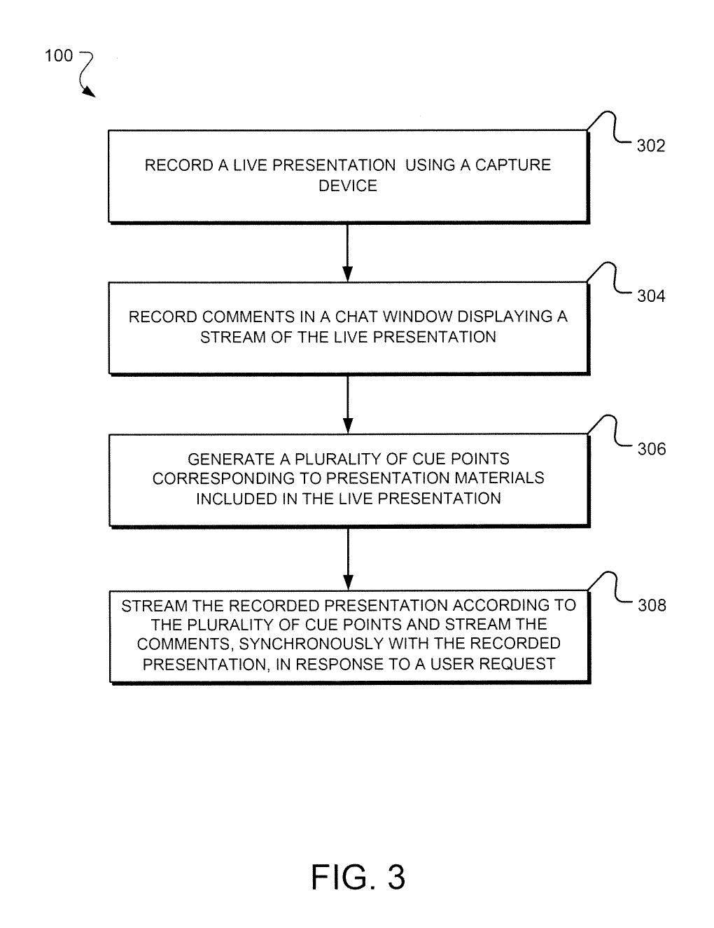

FIG. 3 provides an example method and/or process 300 for recording and displaying comments corresponding to a streaming presentation. Initially, process 300 begins with recording a live presentation using a video and audio capture device (operation 302). For example, a server device containing audio and video equipment may record a live presentation concerning employee benefits for a large corporate entity being broadcasted to a large group of corporate employees. The live presentation may include various presentation materials—webcast slides, video, audio, and the like, all relating to employee benefits.

During the recording of the presentation, one or more comments and/or questions corresponding to the presentation may be received within an online chat window currently streaming the live presentation (operation 304). Referring to the corporate example above, an employee, interested in the healthcare benefits being offered by the firm, may access the user computing device 150 and provide input to generate the question, “what are company's current health care options?” In conjunction with the question submission, a corresponding time timestamp, indicating the time in which the question was provided, is generated and stored in the database 135. Any number of questions, comments and answers may be generated along with corresponding time stamps indicating when the comments, questions, answers, etc., were generated and displayed during the streaming of the live presentation.

In addition to recording comments, various cue points are generated corresponding to any changes in the presentation materials being broadcasted or otherwise streamed within the live presentation (operation 306). For example, assume the live presentation initially include a video outlining healthcare benefits. Subsequently, the live presentation switched to corporate slides highlighting important aspects of the healthcare policy. A cue point is generated corresponding to the slides, indicating a temporal change in presentation materials.

Once any comments, questions, answers, presentation changes etc., have been timestamped, cued, and stored, at a later time and on-demand, the recorded presentation may be re-played or otherwise streamed in conjunction with the recorded comments, questions, answers, etc., in a single cohesive manner that replicates the flow of the comments, questions, answers, and/or chat that occurred during the actual live presentation (operation 308). More particularly, the server 130 may query the database 135 for the various cue points and timestamps corresponding to the various comments, questions, answers, etc., and process any identified cue points and timestamps to provide or otherwise push the comments, questions, answers, etc., in sync with the presentation media at the appropriate time, thereby ensuring that the all the actions remain synchronized and the on-demand experience mirrors the live presentation experience, including any comments.

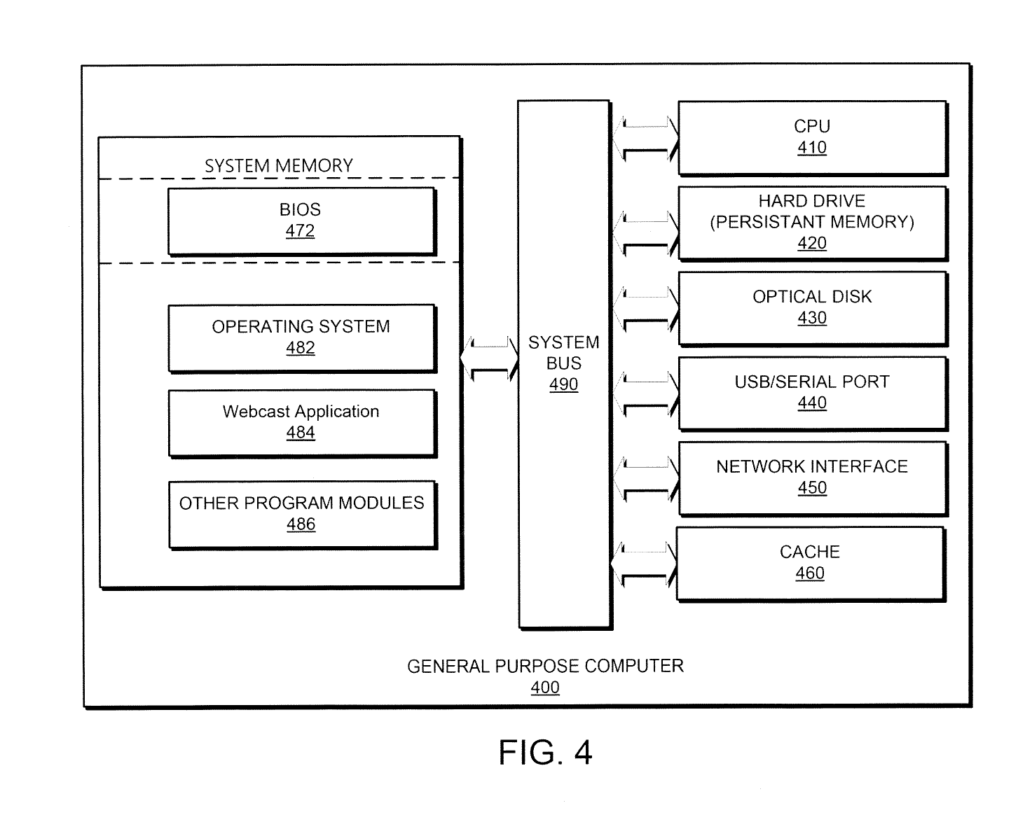

FIG. 4 illustrates an example general purpose computer 400 that may be useful in implementing the described technology. The example hardware and operating environment of FIG. 4 for implementing the described technology includes a computing device, such as general purpose computing device in the form of a personal computer, server, or other type of computing device. In the implementation of FIG. 4, for example, the computing devices 150-180 includes a processor 410, a cache 460, a system memory 470, 480, and a system bus 490 that operatively couples various system components including the cache 460 and the system memory 470, 480 to the processor 410. There may be only one or there may be more than one processor 410, such that the processor of computing devices 150-180 comprises a single central processing unit (CPU), or a plurality of processing units, commonly referred to as a parallel processing environment. The computing devices 150-180 may be a conventional computer, a distributed computer, or any other type of computer; the invention is not so limited.

The system bus 490 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 470 and random access memory (RAM) 480. A basic input/output system (BIOS) 472, containing the basic routines that help to transfer information between elements within the computing devices 150-180 such as during start-up, is stored in ROM 470. The computing devices 150-180 further includes a hard disk drive 420 for reading from and writing to a persistent memory such as a hard disk, not shown and an optical disk drive 430 for reading from or writing to a removable optical disk such as a CD ROM, DVD, or other optical media.

The hard disk drive 420 and optical disk drive 430 are connected to the system bus 490. The drives and their associated computer-readable media provide nonvolatile storage of computer-readable instructions, data structures, program engines and other data for the computing devices 150-180. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program engines may be stored on the hard disk, optical disk, ROM 470, or RAM 480, including an operating system 482, a webcast application 484, and one or more other application programs 486. A user may enter commands and information into the computing devices 150-180 through input devices such as a keyboard and pointing device connected to the USB or Serial Port 440. These and other input devices are often connected to the processor 410 through the USB or serial port interface 440 that is coupled to the system bus 490, but may be connected by other interfaces, such as a parallel port. A monitor or other type of display device may also be connected to the system bus 490 via an interface, such as a video adapter 460. In addition to the monitor, computers typically include other peripheral output devices (not shown), such as speakers and printers.

The computing devices 150-180 may operate in a networked environment using logical connections to one or more remote computers. These logical connections are achieved by a network interface 450 coupled to or a part of the computing devices 150-180; the invention is not limited to a particular type of communications device. The remote computer may be another computer, a server, a router, a network PC, a client, a peer device, or other common network node, and typically includes many or all of the elements described above relative to the computing devices 150-180. The logical connections include a local-area network (LAN) a wide-area network (WAN), or any other network. Such networking environments are commonplace in office networks, enterprise-wide computer networks, intranets and the Internet, which are all types of networks.

The network adapter 450, which may be internal or external, is connected to the system bus 450. In a networked environment, programs depicted relative to the computing devices 150-180, or portions thereof, may be stored in the remote memory storage device. It is appreciated that the network connections shown are example and other means of and communications devices for establishing a communications link between the computers may be used.

The embodiments of the invention described herein are implemented as logical steps in one or more computer systems. The logical operations of the present invention are implemented (1) as a sequence of processor-implemented steps executing in one or more computer systems and (2) as interconnected machine or circuit engines within one or more computer systems. The implementation is a matter of choice, dependent on the performance requirements of the computer system implementing the invention. Accordingly, the logical operations making up the embodiments of the invention described herein are referred to variously as operations, steps, objects, or engines. Furthermore, it should be understood that logical operations may be performed in any order, unless explicitly claimed otherwise or a specific order is inherently necessitated by the claim language.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

What is claimed is:

1. A method for on-demand streaming of a hybrid recording of a live presentation comprising:
recording a live presentation using at least one capture device;
recording, in a memory, comments entered into an online chat window displaying a stream of the live presentation; and
streaming a hybrid recording to a user computer over a network in response to a user request to view the hybrid recording, the hybrid recording including:
the recording of the live presentation;
the comments retrieved from memory; and
wherein the recording of the live presentation and the comments are simultaneously and synchronously displayed in a streaming window.

2. The method of claim 1, wherein the comments include at least one question and wherein recording the comments comprises recording a timestamp corresponding to the at least one question in a database, the timestamp identifying a time at which the at least one question was recorded in relation to the recording of the live presentation.

3. The method of claim 2, wherein the live presentation comprises presentation materials including at least one of slides, pictures, charts, or video and wherein recording the live presentation comprises generating a cue point logging a change in the presentation materials of the live presentation and a duration timestamp identifying a duration time of the live presentation.

4. The method of claim 3, wherein streaming the hybrid recording comprises:
streaming the recording of the live presentation in the streaming window according to the cue point and the duration timestamp; and
streaming the at least one question according to the timestamp in relation to the duration timestamp of the live presentation, thereby synchronously displaying the recording of the presentation and the at least one question included in the comments.

5. The method of claim 1, further comprising generating a user-interface for receiving a configuration of the chat window, the configuration indicating when the comments may be entered into the online chat window.

6. The method of claim 1, wherein the at least one capture device is a server and wherein the chat window is a scrollable chat window of a webcast configured to display the comments at a bottom of the chat window in real-time.

7. A system for on-demand streaming of a hybrid recording of a live presentation comprising:
at least one capture device to record a live presentation; and
at least one processor to:
record, in a memory, comments entered into an online chat window displaying a stream of the live presentation; and
stream a hybrid recording to a user computer over a network in response to a user request, the hybrid recording including:
the recording of the live presentation;
the comments retrieved from memory; and
wherein the recording of the live presentation and the comments are simultaneously and synchronously displayed in a streaming window.

8. The system of claim 7, wherein the comments includes at least one question and wherein recording the comments comprises recording a timestamp corresponding to the at least one question in a database, the timestamp identifying a time at which the at least one question was recorded in relation to the recording of the live presentation.

9. The system of claim 8, wherein the live presentation comprises presentation materials including at least one of slides, pictures, charts, or video and wherein recording the live presentation comprises generating a cue point logging a change in the presentation materials and a duration timestamp identifying a duration time of the live presentation.

10. The system of claim 9, wherein streaming the hybrid recording comprises:
streaming the recording of the live presentation in the streaming window according to the cue point and the duration timestamp; and
streaming the at least one question according to the timestamp in relation to the duration timestamp of the live presentation, thereby synchronously displaying the recording of the live presentation and the at least one question included in the comments.

11. The system of claim 7, further comprising generating a user-interface for receiving a configuration of the stream, the configuration indicating when the comments may be entered into the online chat window.

12. The system of claim 7, wherein the at least one capture device is a server and wherein the chat window is a scrollable chat window of a webcast configured to display the comments at a bottom of the chat window in real-time.

13. A non-transitory computer-readable medium encoded with instructions for on-demand streaming of a hybrid recording of a live presentation, the instructions executable by a processor, comprising:
recording a live presentation using at least one capture device;
recording, in a memory, comments entered into an online chat window displaying a stream of the live presentation; and
streaming a hybrid recording to a user computer over a network in response to a user request, the hybrid recording including:
the recording of the live presentation;
the comments retrieved from memory; and
wherein the recording of the live presentation and the comments are simultaneously and synchronously displayed in a streaming window.

14. The non-transitory computer-readable medium of claim 13, wherein the comments includes at least one question and wherein recording the comments comprises recording a timestamp corresponding to the at least one question in a database, the timestamp identifying when the at least one question was recorded in relation to the recording of the live presentation.

15. The non-transitory computer-readable medium 14, wherein the live presentation comprises presentation materials including at least one of a slides, pictures, charts, or video and wherein recording the live presentation comprises generating a cue point logging a change in the presentation materials of the live presentation and a duration timestamp identifying a duration time of the live presentation.

16. The non-transitory computer-readable medium of claim 15, wherein streaming the hybrid recording comprises:
streaming the video and audio recording of the live presentation in the streaming window according to the cue point and the duration timestamp; and
streaming the at least one question according to the timestamp in relation to the duration timestamp of the live presentation, thereby synchronously displaying the video and audio recording and the at least one question included in the comments.

17. The non-transitory computer-readable medium of claim 13, further comprising generating a user-interface for receiving a configuration of the chat window, the configuration indicating when the comments may be entered into the online chat window.

18. The non-transitory computer-readable medium of claim 13, wherein the at least one capture device is a server and wherein the chat window is a scrollable chat window of a webcast configured to display the comments at a bottom of the chat window in real-time.

19. A system for on-demand streaming of a hybrid recording of a live presentation comprising:
a video and audio capture device to record a live presentation including a plurality of presentation materials; and
at least one processor to:
record comments entered into an online chat window of a webcast displaying a stream of a live presentation, the comments including at least one question and at least one answer corresponding to the at least one question;
generate a first time stamp corresponding to the at least one question and a second time stamp corresponding to the at least one answer;
generate a plurality of cue points, each cue point corresponding to one presentation material of the plurality of presentation materials; and
stream a hybrid recording to a user computer over a network in response to a user request, wherein the hybrid recording includes the at least one question, the at least one answer, and the plurality of presentation materials, the plurality of presentation materials displayed in a streaming window according the plurality of cue points, the at least one question displayed in the streaming window according to the first time stamp, and the at least one answer displayed in the streaming window according to the second time stamp.
